(19) United States
(12) Patent Application Publication
(10) Pub. No.: US 2014/0337505 A1
(43) Pub. Date: Nov. 13, 2014

(54) METHOD FOR DATA TRANSMISSION AND CORRESPONDING ELECTRONIC DEVICE

(71) Applicant: HTC CORPORATION, Taoyuan County (TW)

(72) Inventor: Hsin-Yuan Chang, Taoyuan County (TW)

(73) Assignee: HTC Corporation, Taoyuan County (TW)

(21) Appl. No.: 13/889,369

(22) Filed: May 8, 2013

(51) Int. Cl. H04L 12/26

(52) U.S. Cl. CPC H04L 43/0894
USPC 709/224

(57) ABSTRACT

A method for data transmission and a corresponding electronic device are provided. The method includes the following steps: transmitting a plurality of ping packets, calculating the amount of data received between received acknowledgements of the ping packets, calculating the RTT of the ping packets, and controlling a data transmission rate according to the amount and the RTT.

### BACKGROUND OF THE INVENTION

1. Field of the Invention

The present invention relates to a method for data transmission and a corresponding electronic device. More particularly, the present invention relates to a method for controlling the amount of transmitted data of the electronic device.

2. Description of the Related Art

In a mobile wireless environment such as a 3G telecommunication network, the bandwidth is shared by all users connected to the same base station and the network resource allocated to a user can be changed in 2-10 milliseconds. Consequently, for streaming services like voice over Internet Protocol (VoIP) or video call with the User Datagram Protocol (UDP), a 3G telecommunication network always suffers longer round trip time (RTT) and unstable throughput. When a user is engaged in a video call and the network resource changes very frequently, the other party of the video call may see degraded frame rate, which is undesirable.

### SUMMARY OF THE INVENTION

Accordingly, the present invention is directed to a method for data transmission and a corresponding electronic device. The method and the electronic device can solve the problem of frequent change of network resource by regulating the rate of data transmission to the network dynamically.

According to an embodiment of the present invention, a method for data transmission is provided. The method includes the following steps: transmitting a plurality of ping packets, calculating the amount of data received between received acknowledgements of the ping packets, calculating the RTT of the ping packets, and controlling a data transmission rate according to the amount and the RTT.

According to another embodiment of the present invention, an electronic device is provided. The electronic device includes a network module and a controller. The network module transmits data, receives data, transmits a plurality of ping packets, and receives acknowledgements of the ping packets. The controller is coupled to the network module. The controller calculates the amount of data received between the acknowledgements of the ping packets, calculates the RTT of the ping packets, and controls a data transmission rate according to the amount and the RTT.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing an electronic device according to an embodiment of the present invention.

FIG. 2 is a flow chart showing a method for data transmission according to an embodiment of the present invention.

FIG. 3 is a schematic diagram showing the data transmission and the data reception of an electronic device according to an embodiment of the present invention.

FIG. 4 is a schematic diagram showing the adjustment of the data transmission rate of an electronic device according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

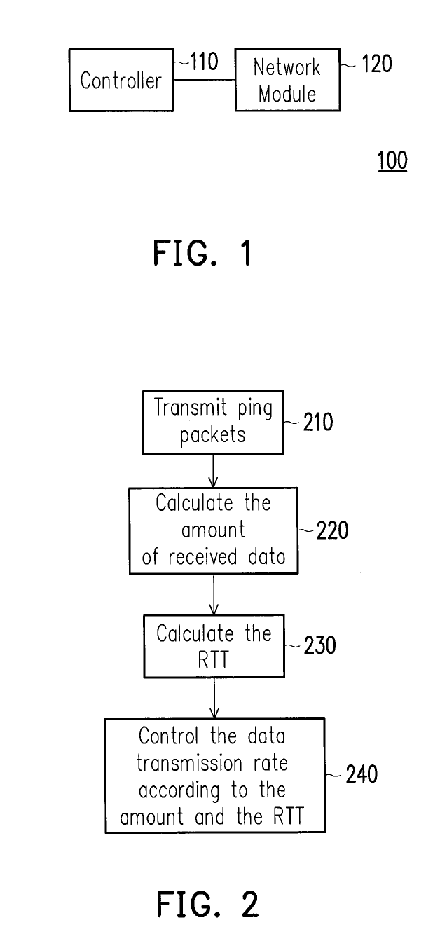

FIG. 1 is a schematic diagram showing an electronic device 100 according to an embodiment of the present invention. The electronic device 100 may be any device that is capable of transmitting data to a network and receiving data from the network, such as a smart phone, a personal digital assistant (PDA), a tablet computer, a notebook computer, or a personal computer. The electronic device 100 includes a controller 110 and a network module 120 coupled to each other. Both of the controller 110 and the network module 120 may be hardware components. The network module 120 transmits data and receives data for the electronic device 100. In addition, the network module 120 transmits a plurality of ping packets and receives the acknowledgements of the ping packets. The aforementioned ping packets may be the echo request packets of Internet Control Message Protocol (ICMP) or other similar packets. The controller 110 controls the data transmission rate of the electronic device 100. The controller 110 may be a control circuit, an embedded controller or a processor of the electronic device 100.

FIG. 2 is a flow chart showing a method for data transmission executed by the electronic device 100 according to an embodiment of the present invention. In this embodiment, the electronic device 100 is connected to a network, such as, but not limited to, a 3G telecommunication network (WCDMA: Wideband Code Division Multiple Access), 4G telecommunication network (LTE: Long-term Evolution), WiMAX (Worldwide Interoperability for Microwave Access) network, or Wi-Fi network.

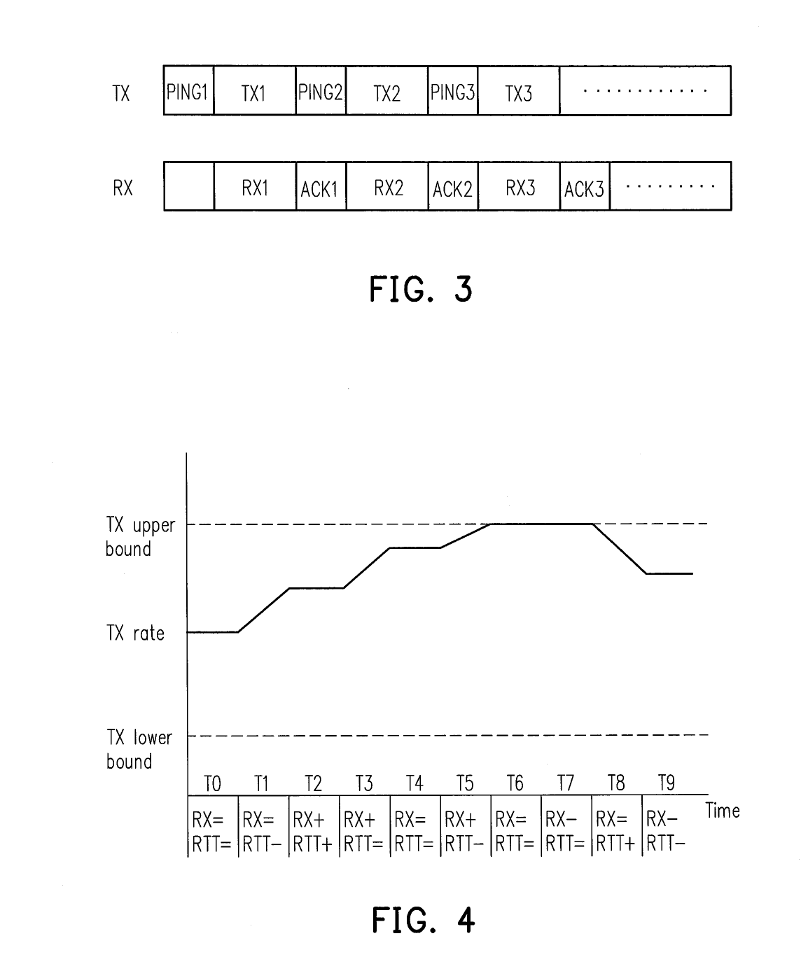

In step 210, the network module 120 transmits a plurality of ping packets to the network and receives acknowledgements of the ping packets from the network. For better understanding of the data transmission and the data reception of the electronic device 100, please refer to FIG. 3. FIG. 3 is a schematic diagram showing the data transmission and the data reception of the network module 120 according to an embodiment of the present invention. In FIG. 3, “TX” means data transmission and “RX” means data reception. PING1, PING2 and PING3 are the ping packets transmitted by the network module 120 to the network. ACK1, ACK2 and ACK3 are the acknowledgments of the ping packets PING1, PING2 and PING3, respectively. TX1, TX2 and TX3 are the data transmitted by the network module 120 to the network. RX1, RX2 and RX3 are the data received by the network module 120 from the network. RX2 is the data received between the two acknowledgments ACK1 and ACK2. RX3 is the data received between the two acknowledgments ACK2 and ACK3. Although the data transmission and the data reception in FIG. 3 are depicted to be temporally aligned, the present invention does not require such temporal alignment.

The ping packets are one of the means used by the electronic device 100 to probe the change of network resource such as network bandwidth. The ping packets have to be transmitted frequently when the network resource allocated to the electronic device 100 changes frequently. In this situation, the period of the transmission of the ping packets may be determined based on the frequency of the change of the network resource. For example, when the network resource can change in 2-10 milliseconds, the network module 120 may transmit a ping packet to the network every 100 milliseconds, which is ten times of the maximum period (10 milliseconds) of network resource change.

Alternatively, the network module 120 may transmit the data TX1, TX2 and TX3 in a form of data packets and transmit each ping packet along with one of the data packets. For example, the ping packet PING1 is transmitted along with the data packet TX1. The ping packet PING2 is transmitted along with the data packet TX2, and so on.

The destination of the ping packets may be a server providing a service to the electronic device 100, a gateway behind the base station serving the electronic device 100, or another electronic device communicating with the electronic device 100. The acknowledgments are the responses to the ping packets generated by the destination of the ping packets.

Next, in step 220 shown in FIG. 2, the controller 110 calculates the amount of the data received by the network module 120 between acknowledgements of the ping packets (“the amount” hereinafter). For example, the amount of RX2 and the amount of RX3 are the amounts of the data received by the network module 120 between two acknowledgements of the ping packets. In step 230, the controller 110 calculates the RTT of the ping packets. In step 240, the controller 110 controls the data transmission rate of the electronic device 100 according to the amount and the RTT. For example, the controller 110 may control the data transmission rate of the electronic device 100 according to the following table.

| | The Amount | | Data Transmission |
|---|---|---|---|
| Entry Number | (RX) | RTT | Rate (TX) |
| 1 | + | = | + |
| 2 | + | + | = |
| 3 | + | − | + |
| 4 | − | = | − |
| 5 | − | + | − |
| 6 | − | − | = |
| 7 | = | = | = |
| 8 | = | + | − |
| 9 | = | − | + |

In the table above, “+” means “increase”, “−” means “decrease”, and “=” means “equal” or “no change”. Each entry of the table indicates the way to adjust the data transmission rate of the electronic device 100 corresponding to a combination of the change of the amount and the change of the RTT. For example, the first entry (+, =, +) of the table means the controller 110 should increase the data transmission rate of the electronic device 100 when the amount increases and the RTT does not change. The fifth entry (−, +, −) of the table means the controller 110 should decrease the data transmission rate of the electronic device 100 when the amount decreases and the RTT increases.

It can be seen in the above table that the change of the data transmission rate is directly proportional to the change of the amount and is inversely proportional to the change of the RTT because both the increment of the amount and the decrement of the RTT indicate better network condition (e.g. better network bandwidth), while both the decrement of the amount and the increment of the RTT indicate worse network condition.

The method for data transmission shown in FIG. 2 is best suitable for two-way data streaming between two electronic devices, such as video call. When the electronic device 100 and another electronic device are engaged in a two-way video call with each other, the network module 120 transmits video frames of the video call to the another electronic device, and the controller 110 may control the data transmission rate of the electronic device 100 by controlling at least one of the frame rate, the frame size, the frame resolution and the quality of the video frames according to the amount and the RTT. In this scenario, both the electronic device 100 and another electronic device improve lag issue of the receiving video frame due to the network resource problem.

According to an embodiment of the present invention, the controller 110 may limit the data transmission rate of the electronic device 100 to a range bounded by a preset upper bound and a preset lower bound. For example, FIG. 4 is a schematic diagram showing the adjustment of the data transmission rate of the electronic device 100 according to an embodiment of the present invention. In FIG. 4, “TX upper bound” and “TX lower bound” are the aforementioned preset upper bound and lower bound, respectively. “TX rate” is the data transmission rate of the electronic device 100. The time axis is divided into ten time slots T0-T9. The change of the amount and the change of the RTT in each time slot are shown below the time axis according to the above table. The controller 110 controls the data transmission rate according to the table above.

The controller 110 increases the data transmission rate by a preset step in time slots T1 and T3, while the controller 110 keeps the data transmission rate unchanged in time slots T0, T2 and T4. In time slot T5, the controller 110 should increase the data transmission rate by a preset step according to the table, but this will boost the data transmission rate to be higher than the preset upper bound. Therefore, the controller 110 sets the data transmission rate to be the preset upper bound. Similarly, the controller 110 sets the data transmission rate to be the preset upper bound in time slot T6. In time slot T7, the controller 110 should decrease the data transmission rate by a preset step according to the table, but the decrement over the preset upper bound in T7 and the increment over the preset upper bound in T6 cancel each other. Therefore, the controller 110 keeps the data transmission rate unchanged in time slot T7. In time slot

T8, the controller 110 decreases the data transmission rate by a preset step according to the table. In time slot T9, the controller 110 keeps the data transmission rate unchanged according to the table.

When the table indicates the controller 110 should decrease the data transmission rate and that will make the data transmission rate lower than the preset lower bound, the controller 110 may simply set the data transmission rate to be the preset lower bound.

In summary, the electronic device and the method for data transmission provide a highly dynamic control mechanism to solve the problem of rapid change of network resource, wherein the data transmission rate is regulated according to the amount of received data and the RTT of ping packets. In some embodiments of the present invention, the data transmission rate may be adjusted progressively in discrete steps.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for data transmission, comprising:
transmitting a plurality of ping packets;
calculating an amount of data received between received acknowledgements of the ping packets;
calculating a round trip time (RTT) of the ping packets; and
controlling a data transmission rate according to the amount and the RTT.

2. The method of claim 1, wherein the step of transmitting the ping packets comprises:
transmitting a plurality of data packets; and
transmitting each of the ping packets along with one of the data packets.

3. The method of claim 1, wherein a period of the transmission of the ping packets is determined based on a frequency of change of a resource of a network, wherein the ping packets are transmitted to the network.

4. The method of claim 1, wherein the method is executed by an electronic device, and wherein a destination of the ping packets is a server providing a service to the electronic device, a gateway behind a base station serving the electronic device, or another electronic device communicating with the electronic device.

5. The method of claim 1, wherein the electronic device and another electronic device are engaged in a two-way video call with each other, and the step of controlling the data transmission rate comprises:
controlling at least one of a frame rate, a frame size, a frame resolution, and a quality of video frames of the video call according to the amount and the RTT.

6. The method of claim 1, wherein a change of the data transmission rate is directly proportional to a change of the amount and is inversely proportional to a change of the RTT.

7. The method of claim 1, wherein the step of controlling the data transmission rate comprises:
limiting the data transmission rate to a range bounded by a preset upper bound and a preset lower bound.

8. An electronic device, comprising:
a network module, transmitting data, receiving data, transmitting a plurality of ping packets, and receiving acknowledgements of the ping packets; and
a controller, coupled to the network module, calculating an amount of data received by the network module between the acknowledgements of the ping packets, calculating a round trip time (RTT) of the ping packets, and controlling a data transmission rate according to the amount and the RTT.

9. The electronic device of claim 8, wherein the network module transmits a plurality of data packets and transmits each of the ping packets along with one of the data packets.

10. The electronic device of claim 8, wherein a period of the transmission of the ping packets is determined based on a frequency of change of a resource of a network, wherein the ping packets are transmitted to the network.

11. The electronic device of claim 8, wherein a destination of the ping packets is a server providing a service to the electronic device, a gateway behind a base station serving the electronic device, or another electronic device communicating with the electronic device.

12. The electronic device of claim 8, wherein the electronic device and another electronic device are engaged in a two-way video call with each other, the network module transmits video frames of the video call to the another electronic device, and the controller controls at least one of a frame rate, a frame size, a frame resolution, and a quality of the video frames according to the amount and the RTT.

13. The electronic device of claim 8, wherein a change of the data transmission rate is directly proportional to a change of the amount and is inversely proportional to a change of the RTT.

14. The electronic device of claim 8, wherein the controller limits the data transmission rate to a range bounded by a preset upper bound and a preset lower bound.
